(19) United States
(12) Patent Application Publication
(10) Pub. No.: US 2025/0093518 A1
(43) Pub. Date: Mar. 20, 2025

(54) METHOD AND SYSTEM FOR MANAGING POSITIONING SIGNALS USING ERROR DATA

(71) Applicant: SAUDI ARABIAN OIL COMPANY, Dhahran (SA)

(72) Inventor: Khaled Nasser Alsoqair, Dhahran (SA)

(73) Assignee: SAUDI ARABIAN OIL COMPANY, Dhahran (SA)

(21) Appl. No.: 18/468,549

(22) Filed: Sep. 15, 2023

(51) Int. Cl. G01S 19/07; G01S 19/04

(52) U.S. Cl. CPC G01S 19/07; G01S 19/04

(57) ABSTRACT

A method may include determining cycle-slip error data using a cycle-slip error detection technique and a first set of positioning signals. The method may further include determining multipath error data using a multipath error detection technique and the first set of positioning signals. The method may further include determining whether the positioning satellites satisfy a predetermined criterion based on the cycle-slip error data and the multipath error data. The method further includes determining a second set of positioning satellites in response to determining that the first set of positioning satellites fail to satisfy the predetermined criterion. The first set of positioning satellites may be different from the second set of positioning satellites. The method may further include obtaining a second set of positioning signals using the second set of positioning satellites. The method further includes determining position data using the second set of positioning signals.

### BACKGROUND

Since the 1980s, Global Navigation Satellite System (GNSS) receivers have relied on a visible set of satellites to determine the location of a GNSS receiver. Initially, there were only a few time periods in a given day that the GNSS receiver could receive signals from four or more positioning satellites, which is the minimum number of satellites needed to calculate the position and time of a GNSS receiver. Accordingly, it was previously necessary to use all available positioning satellites visible in the sky and manipulate the calculations to correct for any noise introduced by the one or more of positioning satellites.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method that includes obtaining, using a global positioning system (GPS) device, a first set of positioning signals for a first set of positioning satellites. The GPS device includes a receiver, a computer processor, an antenna, and a communication interface. The method further includes determining, by the GPS device, whether the GPS device is stationary. The method further includes determining, by the GPS device, whether the GPS device is receiving position correction data from a base station using the communication interface. The method further includes determining, by the GPS device, a cycle-slip error detection technique in response to determining that the GPS device is not stationary and the GPS device is receiving the position correction data from the base station. The method further includes determining, by the GPS device, cycle-slip error data using the cycle-slip error detection technique and the first set of positioning signals. The method further includes determining, by the GPS device, a multipath error detection technique in response to determining that the GPS device is not stationary and the GPS device is receiving the position correction data from the base station. The method further includes determining, by the GPS device, multipath error data using the multipath error detection technique and the first set of positioning signals. The method further includes determining, by the GPS device, whether the positioning satellites satisfy a predetermined criterion based on the cycle-slip error data and the multipath error data. The method further includes determining, by the GPS device, a second set of positioning satellites in response to determining that the first set of positioning satellites fail to satisfy the predetermined criterion. The first set of positioning satellites are different from the second set of positioning satellites. The method further includes obtaining, by the GPS device, a second set of positioning signals using the second set of positioning satellites. The method further includes determining, by the GPS device, position data using the second set of positioning signals.

In general, in one aspect, embodiments relate to a system that includes various positioning satellites, a base station, and a global position system (GPS) device. The GPS device includes a receiver, a memory, a computer processor, an antenna, and a communication interface. The memory includes instructions executable by the computer processor and configured to perform a method. The GPS device further obtains a first set of positioning signals for a first subset of the positioning satellites. The GPS device further determines whether the GPS device is stationary. The GPS device further determines whether the GPS device is receiving position correction data from the base station using the communication interface. The GPS device further determines a cycle-slip error detection technique in response to determining that the GPS device is not stationary and the GPS device is receiving the position correction data from the base station. The GPS device further determines cycle-slip error data using the cycle-slip error detection technique and the first set of positioning signals. The GPS device further determines a multipath error detection technique in response to determining that the GPS device is not stationary and the GPS device is receiving the position correction data from the base station. The GPS device further determines multipath error data using the multipath error detection technique and the first set of positioning signals. The GPS device further determines whether the first subset of positioning satellites satisfy a predetermined criterion based on the cycle-slip error data and the multipath error data. The GPS device determines a second subset of the positioning satellites in response to determining that the first subset of the positioning satellites fail to satisfy the predetermined criterion. The second subset of the positioning satellites are different from the first subset of the positioning satellites. The GPS device further obtains a second set of positioning signals using the second subset of the positioning satellites. The GPS device further determines position data using the second set of positioning signals.

In some embodiments, a set of positioning signals are obtained for various positioning satellites. A respective direction for a respective positioning satellite among the positioning signals may be determined based on the positioning signals. A determination may be made whether the positioning satellites satisfy a first predetermined criterion and a second predetermined criterion. The second predetermined criterion may correspond to at least one satellite from the positioning satellites corresponding to a predetermined range from a north direction, a south direction, an east direction, and a west direction. Various adjusted positioning satellites may be determined in response to the positioning satellites failing to satisfy the first predetermined criterion and the second predetermined criterion. The adjusted positioning satellites may be different from the other positioning satellites. Position data may be determined based on a set of positioning signals for the adjusted positioning satellites. In some embodiments, first carrier phase data of a first positioning signal using a first receiver are determined at a GPS device. Second carrier phase data of a second positioning signal may be determined using a second receiver at the GPS device. Cycle-slip error data may be determined based on a difference between the first carrier phase data and the second carrier phase data. In some embodiments, a first positioning signal is obtained from a first positioning satellite, a second positioning signal is obtained from a second positioning satellite, and a third positioning signal is obtained from a third positioning satellite. A first cycle-slip error value for the first positioning satellite, a second cycle-slip error value for the second positioning satellite, and a third cycle-slip error value for the third positioning satellite may be determined using a machine-learning model and based on the first positioning signal, the second positioning signal, and the third positioning signal, respectively. Cycle-slip error data may include the first cycle-slip error value, the second cycle-slip error value, and the third cycle-slip error value.

In some embodiments, carrier phase data are determined using a receiver in a GPS device. A first positioning signal from a first positioning satellite, a second positioning signal from a second positioning satellite, and a third positioning signal from a third positioning satellite may be obtained by the GPS device. Position correction data may be obtained from a base station using a GPS network protocol. Pseudorange data of the first positioning satellite, the second positioning satellite, and the third positioning satellite may be determined using the first positioning signal, the second positioning signal, and the third positioning signal, respectively. Multipath error data may be determined based on the carrier phase data, the pseudorange data, and the position correction data from the base station.

In some embodiments, a first multipath error value is determined for a first positioning satellite. A second multipath error value may be determined for a second positioning satellite. A third multipath error value may be determined for a third positioning satellite. Dilution-of-precision (DOP) data may be determined for the first positioning satellite, the second positioning satellite, and the third positioning satellite, respectively, using various positioning signals. A set of positioning satellites may be adjusted to produce another set of positioning satellites based on the DOP data. In some embodiments, a first positioning signal from a first positioning satellite, a second positioning signal from a second positioning satellite, and a third positioning signal from a third positioning satellite are obtained respectively. A first multipath error value for the first positioning satellite, a second multipath error value for the second positioning satellite, and a third multipath error value for the third positioning satellite may be determined respectively using a machine-learning model. The multipath error data may include the first multipath error value, the second multipath error value, and the third multipath error value.

In some embodiments, a determination is made whether a GPS device is in a stationary mode based on whether the GPS device is moving using an accelerometer in a user device. In some embodiments, a determination is made whether a GPS device is receiving position correction data from a base station, where the determination includes a communication with the base station using a Radio Technical Commission for Maritime Services (RTCM) protocol. In some embodiments, a predetermined criterion includes a predetermined dilution-of-precision (DOP) threshold.

In some embodiments, a server is coupled to a base station over a network. The server may include a machine-learning model. The server may obtain a first positioning signal from a first positioning satellite, a second positioning signal from a second positioning satellite, and a third positioning signal from a third positioning satellite. The server may determine a first cycle-slip error value for the first positioning satellite, a second cycle-slip error value for the second positioning satellite, and a third cycle-slip error value for the third positioning satellite, respectively, using the machine-learning model and position data for a GPS device, and based on the first positioning signal, the second positioning signal, and the third positioning signal. The server may transmit the cycle-slip error data to the GPS device using the base station. The cycle-slip error data may include the first cycle-slip error value, the second cycle-slip error value, and the third cycle-slip error value.

In some embodiments, a user device includes a GPS device, an accelerometer, and a display device. The GPS device may be determined to be in a stationary mode using the accelerometer. Position data may be presented on the display device.

In light of the structure and functions described above, embodiments of the invention may include respective means adapted to carry out various steps and functions defined above in accordance with one or more aspects and any one of the embodiments of one or more aspect described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1, 2A, 2B, and 2C shows systems in accordance with one or more embodiments.

FIGS. 3A, 3B, 3C, and 3D show examples in accordance with one or more embodiments.

FIG. 4 shows a flowchart in accordance with one or more embodiments.

FIGS. 5A, 5B, 6A, 6B, 6C, 7A, and 7B show examples in accordance with one or more embodiments.

FIG. 8 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for determining a set of positioning satellites based on cycle-slip error data and/or multipath error data. By removing specific satellites responsible for erroneous signal data from position data calculations, position data may be determined with less subsequent noise. In some embodiments, for example, a GPS device identifies and removes various positioning satellites that experience a significant amount of cycle slipping or produce multipath at the GPS device. As such, the GPS device may adjust which positioning satellites are being used to determine the position data that identifies the location of the GPS device. Additionally, satellite removal may be performed through positioning signal post-processing as well as through analog circuitry at the GPS receiver circuit.

Furthermore, a GPS device may analyze each positioning satellite's signal in an epoch-by-epoch fashion (e.g., position reading after position reading by a GPS device) to determine whether any positioning satellites suffer from cycle-slip errors and/or high multipath errors. While various error sources in differential GPS (DGPS), such as clock error, may be canceled using conventional error-correction techniques, two sources of error cannot be readily canceled in a GPS device. More specifically, multipath errors may be caused by both direct and reflected signals reaching a GPS device. Such multipath errors may result from the arrival of a signal from a single source at a GPS device's receiver at slightly different times depending on the path geometry of reflecting surfaces in the vicinity of the GPS device.

Additionally, cycle-slip errors may correspond to a discontinuity or temporary loss of lock of a tracked positioning signal by a GPS device. Thus, a cycle slip may be caused by obstructions similar to sources of multipath errors, such as vertical reflectors (e.g., buildings), as well as other obstructions, such as terrain and trees. Cycle slip errors may also be caused by low signal-to-noise (SNR) ratios and internal GPS tracking problems, such as creeping clock bias resets and incorrect signal processing in the GPS device. In particular, low SNR values may correspond to low satellite elevation over a horizon or atmosphere attenuation of received positioning signals. Once a positioning satellite has been identified with a cycle slip error or a multipath error, the respective positioning satellite may be skipped until the GPS device detects that the error has been resolved where the positioning satellite may be used once again for determining position data. Rather than performing a mitigation technique on positioning signal data, such as using a narrow correlator or double-delta and strobe correlator techniques, some embodiments simply overcome cycle-slip and multipath errors by removing the source of the signal errors.

While the following description makes many references to Global Positioning System (GPS) devices and GPS technologies, the term “GPS” is intended to refer generally to all satellite navigation technologies rather than only the North American satellite positioning system implemented by United States of America. In particular, a GPS device and similar technologies are intended to be interchangeable and refer to various Global Navigation Satellite System (GNSS) technologies, such as any related positioning signal devices implemented by the International Multi-Constellation Satellite System that includes the United States' GPS, GLONASS, Baidu, Galileo, and other constellation systems. However, the term “GPS” is used lexicographically to more easily describe the following technologies and embodiments.

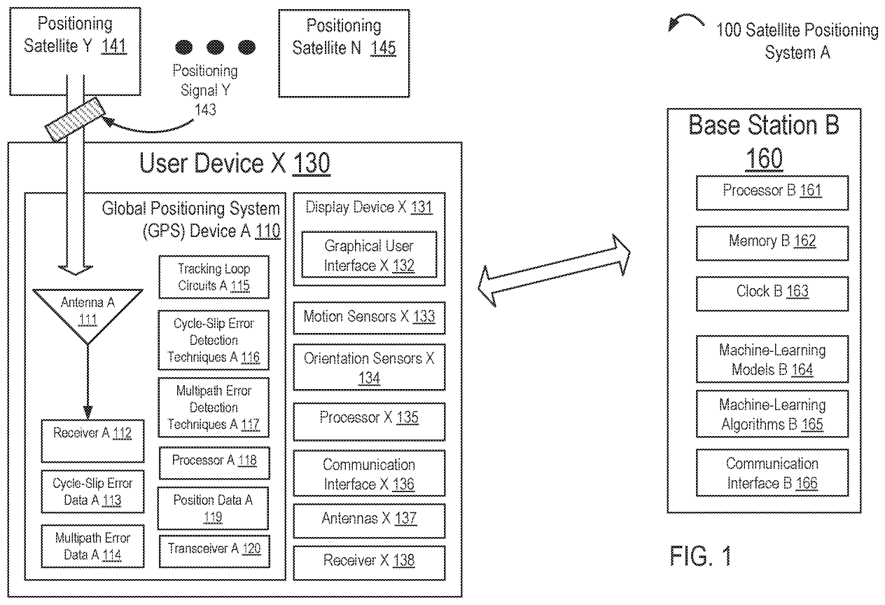

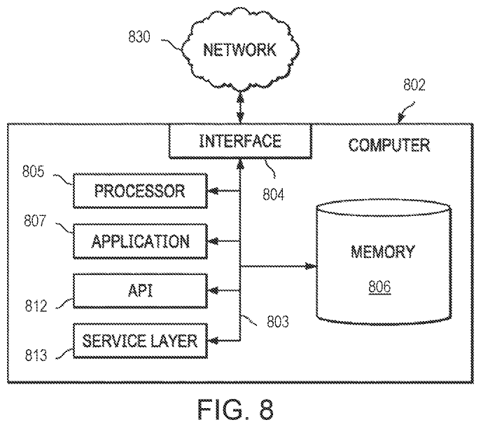

Turning to FIG. 1, FIG. 1 shows a schematic diagram in accordance with one or more embodiments. As shown in FIG. 1, a satellite positioning system (e.g., satellite positioning system A (100)) may include multiple positioning satellites (e.g., positioning satellite Y (141), positioning satellite N (145)), one or more base stations (e.g., base station B (160)), and various user devices (e.g., user device X (130)). The user devices may include one or more GPS devices (e.g., GPS device A (110)), one or more display devices (e.g., display device X (131)) with one or more graphical user interfaces (e.g., graphical user interface X (132)), one or more motion sensors (e.g., motion sensors X (133)), one or more orientation sensors (e.g., orientation sensors X (134)), one or more processors (e.g., processor X (135)), one or more communication interfaces (e.g., communication interface X (136)), one or more antennas (e.g., antenna X (137)), and one or more receivers (e.g., receiver X (138)). User devices may include personal computers, handheld computer devices such as a smartphone or personal digital assistant, an automotive vehicle, an autonomous drone, a human machine interface (HMI) device, as well as other types of devices. In some embodiments, user devices, base stations, and/or GPS devices include computer systems similar to computer system (802) shown in FIG. 8 and the accompanying description.

Turning to GPS devices, a GPS device may include various components for obtaining and/or processing one or more positioning signals (e.g., positioning signal Y (143)) from one or more positioning satellites (e.g., positioning satellite Y (141), positioning satellite N (145)). A GPS device may include one or more antennas (e.g., antenna A (111)), one or more receivers (e.g., receiver A (112)), one or more transmitters and/or transceivers (e.g., transceiver A (120)), one or more processors (e.g., processor A (118)), and one or more tracking loop circuits (e.g., tracking loop circuit A (115)). For example, a GPS device may determine position data (e.g., position data A (119), such as sub-millisecond pseudoranges) that describes the location of the GPS device with respect to one or more positioning satellites using one or more antennas and one or more receivers. In particular, a GPS device may include software and/or hardware for processing positioning signals to form sub-millisecond pseudoranges on a particular signal path from a corresponding positioning satellite. Moreover, positioning satellites may broadcast on various carrier frequencies, such as L1 (i.e., centered at 1575.42 MHz), L2 (i.e., centered at 1227.6 MHz), and L5 (i.e., centered at 1176 MHz). As such, positioning satellites may broadcast a spread-spectrum waveform, called a pseudo-random noise (PRN) code on a particular frequency band (e.g., L1 and L2), where a respective positioning satellite may be identified using the PRN code that it transmits. Additionally, an L5 signal may be used by a GPS device to determine position data that is both ionosphere-free and geometry-free and that uses only carrier phase measurements. In other words, geometry-ionosphere-free (GIF) data may be used in a variety of applications, such as identification of subtle variations in positioning satellite hardware biases to fixing of integer ambiguities and cycle slips. Likewise, a PRN code may be a coarse acquisition (C/A) code or a precision (P) code. A C/A code may be transmitted one the L1 band with a chip rate of 1023 chips per millisecond, for example, while a P code may be transmitted on L1 and L2 bands with a chip rate of 10230 chips per millisecond. Thus, the distance between a GPS receiver and a positioning satellite may correspond to a function of the propagation time and the wave speed of the positioning signal. In addition to the code measurement, the positioning satellite may emit carrier phase measurements which enables high-precision positioning (e.g., determining a location within 2-3 centimeters of the GPS device) with high accuracy. The phase of the carrier wave may be modulated using the PRN code to differentiate between positioning signals from respective positioning satellites and to provide signal timing information for range measurements. Thus, reducing the carrier phase uncertainty may also improve location accuracy.

Keeping with GPS devices, a GPS device may further include one or more tracking loop circuits (e.g., tracking loop circuits A (115)). For example, a tracking loop circuit may be a hardware circuit that include a phase lock loop, a pre-advance/retard component, a pseudo-random sequence generator, and/or one or more correlators. Additionally, a tracking loop circuit may be used to determine the time required for a positioning signal from a positioning satellite to reach the GPS device through the atmosphere. Using a pseudo-random sequence generated by a pseudo-random sequence generator, a tracking loop circuit may determine a time delay or travel time in receiving a pseudo-random sequence from a positioning satellite. This time delay may correspond to the time required for positioning signals to travel from a positioning satellite to a GPS device accordingly. Because the travel speed of positioning signals is known, the distance between a positioning satellite and the GPS device may be determined from the time delay for calculating position data. As such, a GPS device may pair a tracking loop circuit with a corresponding positioning satellite to determine position data for the GPS device in addition to performing one or more error detection techniques (e.g., cycle-slip error detection techniques A (116), multipath error detection techniques A (117)).

Moreover, a GPS device may determine the travel time of a positioning signal from a positioning satellite by comparing the “pseudo random code” from a tracking loop circuit with an identical code in the positioning signal from the satellite. As such, the tracking loop circuit may slide the GPS device's code later and later in time until the two codes sync up, where the sliding amount may be equal to the signal's travel time between the positioning satellite and the GPS device. However, bits or cycles of the pseudo random code may be so wide that a positioning signal and a tracked loop circuit are not perfectly synced, resulting in code measurements that may only be precise to the meter level. Additionally, a GPS device may use the tracked loop circuit to determine carrier phase data. For example, a carrier phase measurement may correspond to a measure of the range between a positioning satellite and the GPS device expressed in units of cycles of the carrier frequency. Likewise, pseudorange position estimates based on coding techniques may be referred to as “pseudoranges” because this information does not give accurate range measurements, but good position estimations up to a few meters.

Furthermore, GPS data, such as position correction data (e.g., raw GPS data received at the base station and the surveyed position of the base station using positioning signals for real-time kinematics (RTK) positioning) may be transmitted between a GPS device and a base station (e.g., base station B (160)) over a wireless communication link. For example, a base station may be a radio tower, such as a tower on a cellular phone network. Thus, a base station may operate as a server for multiple GPS devices for use in determining true position data based one or more positioning signals. Likewise, a base station may communicate with one or more servers over a computer network, such for performing one or more machine-learning techniques. In some embodiments, a base station may allocate a time tag from a local real time clock (e.g., clock B (163)), thus creating an a-priori estimate of the absolute time at which the GPS device received one or more positioning signals from one or more positioning satellites. More specifically, a base station may use various pseudoranges to determine an unknown GPS device's position and absolute time. In some embodiments, a base station transmits sub-millisecond pseudoranges and tower identification data to another server. Additionally, a base station or a coupled server may include one or more processors (e.g., processors B (161)), one or more memories (e.g., memory B (162)), one or more communication interfaces (e.g., communication interface B (166)), and one or more databases, such as a tower location database. For example, a tower location database may provide a location of the base station for determining position data for one or more GPS devices.

In some embodiments, a GPS device uses different GPS modes to determine position data, correct position data, and/or adjusting a set of positioning satellites for selecting positioning signals. For example, one GPS mode may be a standalone mode or a stationary mode (also referred to as single point positioning mode). In a stationary mode, a GPS device uses pseudo range observations from a single receiver (i.e., C/A code or P code data) for determining location coordinates of the GPS device, which may only be accurate to several meters. In another mode, a GPS device establishes a network connection to one or more base stations to obtain position correction data for use in conjunction with one or more positioning signals. For example, one or more base station modes may use differential GPS (DGPS) where base stations may provide a fixed known position to adjust real time positioning signals for eliminating errors, such as multipath errors and cycle-slip errors. In particular, a base station may transmit range error corrections to one or more GPS devices in real-time. Additionally, a GPS device may use one or more kinematics modes with or without a network connection to a base station. A kinematics mode may be used by a GPS device when the GPS is undergoing movement, such as changes in velocity, acceleration, and/or orientation. In one example of a kinematics mode, a GPS device may use a Real-Time Kinematic (RTK) method to determine position data. For example, an RTK method is a specific type of differential GPS processing, where position data is determined using a base-station receiver setup at a known location and a rover (e.g., the GPS device) that obtains corrections from one or more base stations or a network of base stations. With an RTK method, a live communications link may exist between the rover and the base station in order to remove errors such as ionospheric and satellite clock errors from the position data. Likewise, an RTK method may use a network protocol, such as Radio Technical Commission for Maritime Services (RTCM) or Networked Transport of RTCM via Internet Protocol (NTRIP) transmitting DGPS corrections to the GPS device. Moreover, different observation modes may have different terms of accuracy and different observation times (e.g., 1 second to 5 minutes) for analyzing positioning signals.

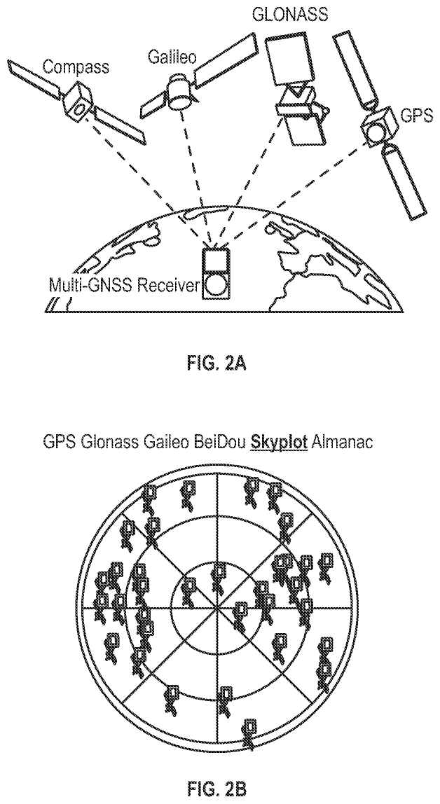

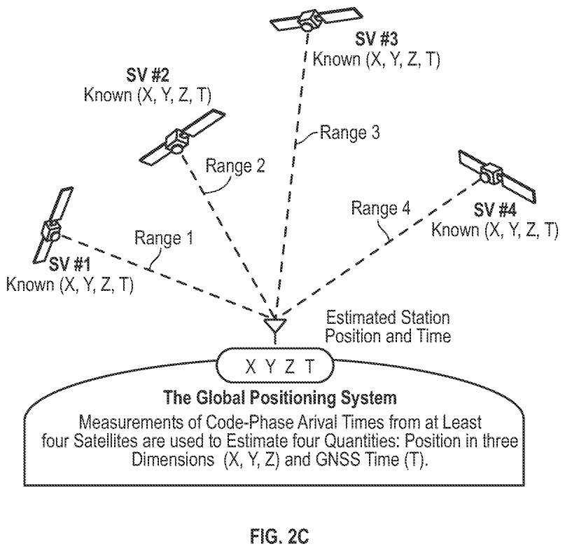

Turning to FIGS. 2A-2C, FIGS. 2A-2C show diagrams of various positioning satellite systems in accordance with one or more embodiments. In FIG. 2A, a satellite positioning system is shown that includes various Global Positioning System (GPS) satellites (i.e., for the United States of America), GLONASS satellites (i.e., for Russia), Galileo satellites (i.e., for the European Union) and Beidou satellites (i.e., for China). By having multiple positioning satellites from multiple countries, a high redundancy is achieved for visible satellites beyond the minimum needed number of positioning satellites. For example, FIG. 2B shows a maximum number of 30 positioning satellites that are visible to a particular GPS device, while a minimum number of 17 positioning satellites may be used at any location on earth in a particular epoch for determining position data for a GPS device. However, the higher number of positioning satellites available for use in determining position data may not necessarily mean better position accuracy as some positioning satellites may introduce various errors into position data calculations.

Turning to FIG. 2C, FIG. 2C shows a GPS device using multiple positioning satellites to determine a location of the GPS device in accordance with one or more embodiments. For example, a positioning satellite may be equipped with an atomic clock that is precisely synchronized on land and on the sky. The positioning satellite may also be equipped with electronic chips to emit positioning signals with coded measurements at exact coded times, and the user's GPS device to collect coded messages from all viewed positioning satellites in the sky. Moreover, positioning satellites may also broadcast ephemeris messages which contains information about the satellite's position relative to the earth coordinates system. For example, an ephemeris message may include data corresponding to various Cartesian Coordinates (X, Y, Z) of the satellite's antenna position relative to earth+the synchronized time when the signal was broadcasted. Four positioning satellites may be the minimum number for position data, because known cartesian coordinates of the observed satellites may be used to obtain a GPS device's antenna position by solving for the unknown cartesian coordinates of the GPS device (δx, δy, δz, δt), where, δx X component of the GPS device, δy Y component of the GPS device, δz Z component of the GPS device, δt clock time of the GPS device when the positioning signal from the satellite was received.

Returning to FIG. 1, a user device may include hardware and/or software for determining orientation, velocity, and other motion characteristics regarding changes in position of the user device. For example, a user device may include an inertial navigation system (INS) that uses motion sensors (e.g., accelerometers) and/or rotation sensors (e.g., gyroscopes), magnetic sensors, and barometric altimeters. Likewise, position data from an INS device may be analyzed by one or more processors within the user device, such as in conjunction with one or more GPS devices. Thus, a user device may operate on a dead reckoning system, where initial position data, initial velocity data, and initial orientation data may be provided by an external source, such as an onboard GPS device. Equipped with this data, a user device may determine the position, velocity and other movement data of the user device from various sensor measurements. As the user device continues to move, an INS device may continue to calculate and update position data via sensor data received from various motion sensors and/or rotation sensors.

Keeping with motion and orientation data, a gyroscope may be used for measuring a user device's orientation (e.g., angular velocity) relative to an inertial reference frame. The inertial reference frame may be provided by the original orientation of the user device, to which angular velocity is added so that the inertial navigation system's direction is always available. On the other hand, accelerometers may determine motion data, such as speed and direction of acceleration, based on one or more measurements of linear acceleration of the user device. For example, angular velocity together with linear acceleration may provide accurate position data of a moving user device. Likewise, a user device may also be equipped with magnetometers that may be used to determine a user device's heading (e.g., in a similar manner as performed by a compass). In some embodiments, various motion and/or orientation sensors are micro-electromechanical systems (MEMS) that are integrated into mobile terminals and smart wearable devices for pedestrian systems.

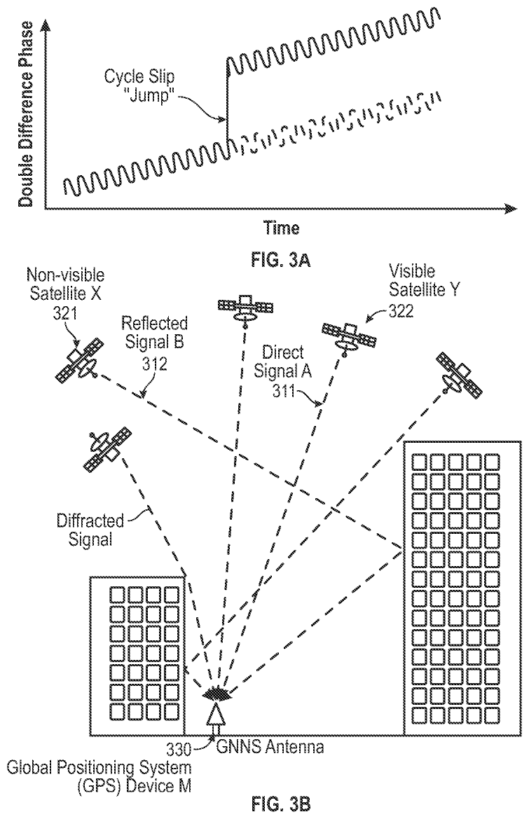

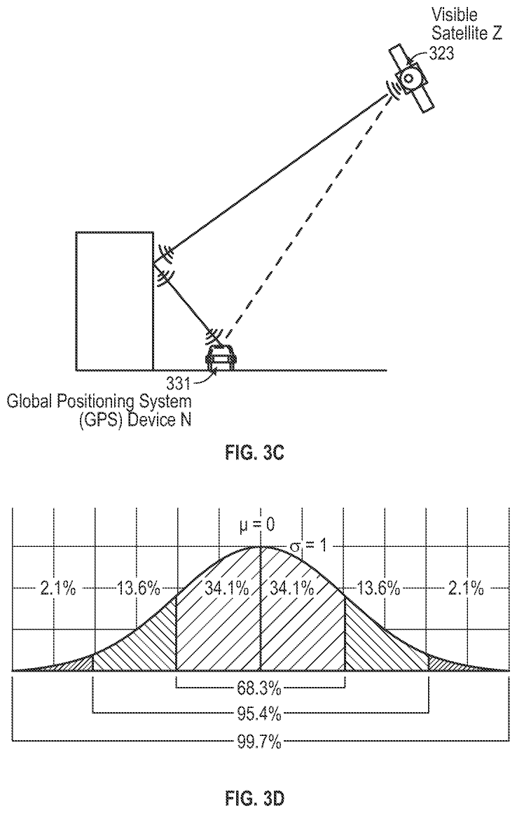

Turning to FIG. 3A, FIG. 3A shows cycle-slip error in accordance with one or more embodiments. In FIG. 3A, an example of cycle slipping is shown where a GPS receiver loses phase lock on a positioning signal due to various reasons, such as an obstruction between a positioning satellite and a GPS device's antenna or when the positioning satellite starts to arise from earth's horizon. In particular, cycle slips may be discrete and rapid changes in the bias of a carrier phase measurement. More specifically, cycle slips may occur based on the difference between a reference phase and a true phase change being too much from epoch to epoch in determining position data for a GPS device. In other words, a GPS device's tracked loop circuit may lose a phase lock on a positioning signal based on one or more cycle slips. Afterwards, the residual measurement in the tracked loop circuit may not reflect the actual phase difference such that cycle slips may occur until a phase lock is reestablished. In another situation, cycle slip may occur where noise dominates the positioning signal, such that the residual phase measurements jump around and the unwrap operation introduces cycle slip errors. In another situation, the positioning signal experiences multipath errors, where the residual baseband signal Δs can wrap around a complex origin. This phenomenon may be referred to as a phase transition, which produces a cycle slip error when the complex signal is unwrapped by a tracking loop circuit.

Keeping with cycle-slip errors, various factors may contribute to cycle slip errors, such as signal blockage, low signal-to-noise ratio, high platform dynamics, and various effects of propagation through a turbulent ionosphere or troposphere. In other words, harsh signal propagation conditions may produce an environment for cycle slips that affect carrier phase measurements. When left uncorrected, cycle slips introduce persistent biases into a position data model that is used for a wide range of GPS applications. Moreover, the presence of excessive noise or uncertain background trends may conceal cycle slip errors and decrease the probability of their identification by a GPS device. Likewise, multiple consecutive cycle slips can also exacerbate such errors. Thus, consecutive slip occurrences may be present in position data determined under the conditions of multipath, weak signal power, strong atmospheric or ionospheric disturbances, and highly dynamic receiver platforms.

In some embodiments, a user device includes hardware and/or software to determine cycle-slip error data using one or more cycle-slip error detection techniques. Using positioning signals, for example, a cycle slip may be detected using the carrier phase measurements determined by a GPS device. Other methods for detecting cycle-slip errors may depend on different GPS modes, such as whether a GPS device is stationary or moving, and whether the GPS device is connected to a base station or in a roving mode. In some embodiments, for example, a cycle slip is detected in a rover mode when there a carrier phase measurement jumps while operating in the double difference phase lock (e.g., as shown in FIG. 3A) between two GPS receivers (i.e., delta phase=carrier phase at base station−carrier phase at rover). Various cycle-slip detection approaches may determine cycle-slip errors using just two measurement epochs or a single epoch of time-differenced measurements. These techniques may operate under signal conditions with carrier phase measurements of 1 Hz or slower sampling frequencies. For example, zero faulty cycle-slip estimates may be used with 1 Hz GPS data even with phase noise standard deviations reaching up to ½ cycle.

Furthermore, a cycle slip may be determined to have occurred in a set of carrier phase measurements φ(t), which are thus analyzed for determining when the cycle-slip error occurred and what was the amplitude of the cycle slip. In particular, a GPS device may analyze carrier phase data that includes an L5 signal phase in the presence of a larger overall phase trend and noise. Likewise, carrier phase measurements may be compared against different positioning signals, such as between an L1 signal and an L5 signal that are transmitted by the same positioning satellite (i.e., because both positioning signals may show similar phase trends). Some cycle-slip detection techniques analyze single or dual-frequency GPS L1 and L2 signals and determined various outliers in specific combinations of measurements. For instance, a Kalman filter may be applied to a geometry-free carrier phase signal combination to detect outliers in its variation as cycle slips. As such, some embodiments use various positioning signal characteristics to detect a cycle-slip error, such as slip characteristics, noise amplitude, and background trends of carrier phase measurements.

Turning to FIGS. 3B and 3C, FIGS. 3B and 3C shows positioning satellite systems with various multipath errors in accordance with one or more embodiments. As shown in FIG. 3B, a GPS device M (330) receives various direct signals from various positioning satellites (e.g., direct signal A (311) from visible satellite Y (322)) and various reflected signals from various positioning satellites (e.g., reflected signal B (312) from non-visible satellite X (321)). For example, positioning signals may be reflected on the ground and one or more reflectors on a particular path, such as a vertical obstacle (e.g., a building). The direct signals and reflects signals may arrive at a GPS device and be superimposed on the total received positioning signal. Thus, the GPS device may be determining position data using both direct signal components and multipath signal components, thereby resulting in multipath error. As such, multipath errors may include local uncorrelated multipath errors (i.e., a single satellite transmitting a multipath signal to a single antenna) and correlated multipath errors (i.e., a single satellite transmitting positioning signals to more than one antenna). In addition, Non-Line-Of-Sight (NLOS) multipath may describe the absence of any direct signals from a visible satellite to a GPS device and only the presence of reflected multipath signals being received at the GPS device. Moreover, such multipath errors may result in very high code measurement errors and finally errors of the position determination. In GPS devices applying or generating differential corrections for position data (e.g., ground-based augmentation system (GBAS) correction, satellite-based augmentation system (SBAS) correction), multipath may be the largest error source at the GPS device. Likewise, FIG. 3C shows a GPS device N (331) that experiences a multipath error based on receiving both a direct signal and a reflected signal from a visible positioning satellite Z (323).

Keeping with multipath errors, multipath errors may be considered a significant challenge for GPS devices since multipath cannot be modulated or easily predicted. FIG. 3C shows an extreme example of multipath is an urban canyon in a city center. In some embodiments, a multipath error value determined using linear combinations of carrier phase and pseudorange measurements. In this example, multipath error data may include an RMS value of the pseudorange multipath error introduced in meters to each visible satellite in view at a particular epoch. Moreover, values of the multipath error for each positioning satellite may be determined at each epoch along with their mean and standard deviation.

Turning to FIG. 3D, FIG. 3D shows a normal distribution of a range of multipath error values in accordance with one or more embodiments. For example, a GPS device may choose the best standard deviation to satisfy the position precision while maintaining an acceptable dilution-of-precision (DOP) value. In particular, a DOP value may describe the characterization of visible satellite geometry to a GPS device. In other words, relative satellite-receiver geometry may play a major role in determining the location precision of determining positions and travel times. Due to the relative geometry of a positioning satellite to a receiver, the precision of the pseudorange values may translate to a corresponding component in each of the four dimensions of position measured by a GPS device (i.e., δx, δy, δz, δt). The precision of multiple positioning satellites in view of a GPS device may combine according to the relative position of the positioning satellites to determine the level of precision in each physical dimension of the receiver measurement, such as in the x-axis or y-axis. By disrupting the relative geometry of a positioning satellite by removing them harshly, position data may lose accuracy than before removing certain positioning satellites from the position data calculations. As such, DOP values may provide a magnification factor effect of user ranging error towards the positioning solution determined by a GPS device. For example, position data error may be expressed using the following equation:

$$3 D error = User range error * DOP value \qquad Equation 1$$

For illustration of Equation 1, a pseudorange error of 2 meters with a DOP value of ‘3’ may result in a three-dimensional error of 6 meters. Table 1 below shows positioning solution conditions based on their corresponding DOP values:

TABLE 1

| DOP Value | Rating | Description |
|---|---|---|
| <1 | Ideal | Highest possible confidence level to be used for applications demanding the |
| | | highest possible precision at all times. |
| 1-2 | Excellent | At this confidence level, positional measurements are considered accurate |
| | | enough to meet all but the most sensitive applications. |
| 2-5 | Good | Represents a level that marks the minimum appropriate for making accurate |
| | | decisions. Positional measurements could be used to make reliable in-route |
| | | navigation suggestions to the user. |
| 5-10 | Moderate | Positional measurements could be used for calculations, but the fix quality |
| | | could still be improved. A more open view of the sky is recommended. |
| 10-20 | Fair | Represents a low confidence level. Positional measurements should be |
| | | discarded or used only to indicate a very rough estimate of the current |
| | | location. |
| >20 | Poor | At this level, measurements are inaccurate by as much as 300 meters with a |
| | | 6-meter accurate device (50 DOP × 6 meters) and should be discarded |

Returning to FIG. 1, in some embodiments, a user device determines multipath error data (e.g., multipath error data A (114) and/or cycle-slip error (e.g., cycle-slip error data A (113)) for one or more positioning signals. For example, a user device may include hardware and/or software for detecting one or more flagged satellites that are rejected instantaneously in an epoch-by-epoch fashion whether the observation is static (i.e., a GPS device is stationary), Kinematic (i.e., a GPS device is moving) or PPP (i.e., standalone without base station) in order to obtain the optimum positioning result with less signal-to-noise (SNR) ratio in the analyzed positioning signals than before. Depending on the type of positioning situation, several multipath error detection techniques may be used to determine multipath error data. For example, multipath mitigation may be performed at the hardware level as well as the software level. At the hardware level, the use of high-quality antenna arrays may be used for detecting multipath signals, as well as determining multipath parameters describing the reflected signals. Multipath errors may also be detected at the software level of a GPS device in signal acquisition as well as using data within various tracking loop circuits.

As a GPS device tracks a direct signal contaminated by delayed reflections, several multipath mitigation methods may be used based on a narrow correlator Delay Lock Loop (DLL). Some examples include the use of a strobe correlator, an early-late-slope technique, a double-delta correlator, and a multipath intensive delay lock loop. On the other hand, a statistical approach based on the maximum likelihood principle or a Bayesian technique may be used to determine and correct multipath errors in a positioning signal calculation. However, in the case of Non-Line-of-Sight (NLOS) effect, multipath a Generalized Likelihood Ratio Test (GLRT) or a Marginalized Likelihood Ratio Test (MLRT) may be used for fault detection and diagnosis.

In some embodiments, a user device determines cycle-slip error data and/or multipath error data using one or more machine-learning models. For example, a machine-learning model may perform a code multipath error prediction using positional signal data as well as data relating to ground fixed based stations. Additionally, different types of input features may be used to detect multipath signals. For example, non-line of sight (NLOS) multipath detection may be performed using features directly extracted from a correlator's output. Likewise, a convolutional neural network may obtain a feature map that is extracted from multivariable time series data from the end of signal processing stage in a GPS device. Moreover, early-late phase data, delta data, and signal level data may be input features extracted from a tracking loop circuit and subsequently used in a deep neural network. In some embodiments, a correlator's output signal is mapped as a 2D input image and fed to an artificial neural network. Thus, the artificial network automatically extracts the relevant features from the input samples and proceeds with the multipath detection accordingly.

Keeping with FIG. 1, a user device, a GPS device, and/or a server (e.g., a base station B (160) or a remote server) may include hardware and/or software with functionality for generating and/or updating one or more machine-learning models (e.g., machine-learning models B (164)) to determine predicted error data based on one or more positioning signals. Examples of machine-learning models may include random forest models and artificial neural networks, such as convolutional neural networks, fully-connected neural networks, deep neural networks, and recurrent neural networks. Machine-learning models may also include support vector machines, decision trees, inductive learning models, deductive learning models, supervised learning models, unsupervised learning models, reinforcement learning models, and the like. In a deep neural network, for example, a layer of neurons may be trained on a predetermined list of features based on the previous network layer's output. Thus, as data progresses through the deep neural network, more complex features may be identified within the data by neurons in later layers. In some embodiments, two or more different types of machine-learning models are integrated into a single machine-learning architecture, e.g., a machine-learning model may include a random forest model and various neural networks. In some embodiments, a server or other computer system may generate augmented data or synthetic data to produce a large amount of interpreted data for training a particular model.

In some embodiments, various types of machine-learning algorithms (e.g., machine-learning algorithms B (165)) may be used to train the model, such as a backpropagation algorithm. In a backpropagation algorithm, gradients are computed for each hidden layer of a neural network in reverse from the layer closest to the output layer proceeding to the layer closest to the input layer. As such, a gradient may be calculated using the transpose of the weights of a respective hidden layer based on an error function (also called a “loss function”). The error function may be based on various criteria, such as mean squared error function, a similarity function, etc., where the error function may be used as a feedback mechanism for tuning weights in the machine-learning model.

In some embodiments, a machine-learning model is trained using multiple machine-learning epochs. For example, a machine-learning epoch may be an iteration of a model through a portion or all of a training dataset. As such, a single machine-learning epoch may correspond to a specific batch of training data, where the training data is divided into multiple batches for multiple machine-learning epochs. Thus, a machine-learning model may be trained iteratively using machine-learning epochs until the model achieves a predetermined criterion, such as predetermined level of prediction accuracy or training over a specific number of machine-learning epochs or iterations. Thus, better training of a model may lead to better predictions by a trained model.

With respect to artificial neural networks, for example, an artificial neural network may include one or more hidden layers, where a hidden layer includes one or more neurons. A neuron may be a modelling node or object that is loosely patterned on a neuron of the human brain. In particular, a neuron may combine data inputs with a set of coefficients, i.e., a set of network weights for adjusting the data inputs. These network weights may amplify or reduce the value of a particular data input, thereby assigning an amount of significance to various data inputs for a task being modeled. Through machine learning, a neural network may determine which data inputs should receive greater priority in determining one or more specified outputs of the artificial neural network. Likewise, these weighted data inputs may be summed such that this sum is communicated through a neuron's activation function to other hidden layers within the artificial neural network. As such, the activation function may determine whether and to what extent an output of a neuron progresses to other neurons where the output may be weighted again for use as an input to the next hidden layer.

Turning to fully-connected neural networks, a fully connected neural network may include a series of fully connected layers (e.g., an input layer, one or more hidden layers, and an output layer) that connect each neuron in one layer to every neuron in the next layer. As such, fully-connected neural networks may be referred to as “structurally agnostic” in that there are no special assumptions needed to be made about the input data, such whether the input is an image, a continuous range of values, and/or categorized inputs.

Turning to convolution neural networks, a convolution neural network may obtain images as input data, which may allow encoding certain properties into the network's model architecture. For example, a convolution neural network may include a sequence of hidden layers, where a hidden layer may transform one volume of activations to another set of activations through a differentiable function. Examples of specific hidden layers in a convolution neural network include convolutional layers, pooling layers, fully-connected layers, and/or normalization layers. Likewise, a U-net model or other type of convolutional neural network model may use these different types of layers to produce a particular type of output.

Turning to recurrent neural networks, a recurrent neural network (RNN) may perform a particular task repeatedly for multiple data elements in an input sequence (e.g., a sequence of carrier phase measurements and/or pseudorange measurements for different positioning satellites), with the output of the recurrent neural network being dependent on past computations. As such, a recurrent neural network may operate with a memory or hidden cell state, which provides information for use by the current cell computation with respect to the current data input. For example, a recurrent neural network may resemble a chain-like structure of RNN cells, where different types of recurrent neural networks may have different types of repeating RNN cells. Likewise, the input sequence may be time-series data, where hidden cell states may have different values at different time steps during a prediction or training operation. For example, where a deep neural network may use different parameters at each hidden layer, a recurrent neural network may have common parameters in an RNN cell, which may be performed across multiple time steps. To train a recurrent neural network, a supervised learning algorithm such as a backpropagation algorithm may also be used. In some embodiments, the backpropagation algorithm is a backpropagation through time (BPTT) algorithm. Likewise, a BPTT algorithm may determine gradients to update various hidden layers and neurons within a recurrent neural network in a similar manner as used to train various deep neural networks.

Embodiments are contemplated with different types of RNNs. For example, classic RNNs, long short-term memory (LSTM) networks, a gated recurrent unit (GRU), a stacked LSTM that includes multiple hidden LSTM layers (i.e., each LSTM layer includes multiple RNN cells), recurrent neural networks with attention (i.e., the machine-learning model may focus attention on specific elements in an input sequence), bidirectional recurrent neural networks (e.g., a machine-learning model that may be trained in both time directions simultaneously, with separate hidden layers, such as forward layers and backward layers), as well as multidimensional LSTM networks, graph recurrent neural networks, grid recurrent neural networks, etc. With regard to LSTM networks, an LSTM cell may include various output lines that carry vectors of information, e.g., from the output of one LSTM cell to the input of another LSTM cell. Thus, an LSTM cell may include multiple hidden layers as well as various pointwise operation units that perform computations such as vector addition.

In some embodiments, one or more ensemble learning methods are used to produce a hybrid-model architecture. For example, an ensemble learning method may use multiple types of machine-learning models to obtain better predictive performance than available with a single machine-learning model. In some embodiments, for example, an ensemble architecture may combine multiple base models to produce a single machine-learning model. One example of an ensemble learning method is a BAGGing model (i.e., BAGGing refers to a model that performs Bootstrapping and Aggregation operations) that combines predictions from multiple neural networks to add a bias that reduces variance of a single trained neural network model. Another ensemble learning method includes a stacking method, which may involve fitting many different model types on the same data and using another machine-learning model to combine various predictions.

Turning to random forests, a random forest model may an algorithmic model that combines the output of multiple decision trees to reach a single predicted result. For example, a random forest model may be composed of a collection of decision trees, where training the random forest model may be based on three main hyperparameters that include node size, a number of decision trees, and a number of input features being sampled. During training, a random forest model may allow different decision trees to randomly sample from a dataset with replacement (e.g., from a bootstrap sample) to produce multiple final decision trees in the trained model. For example, when multiple decision trees form an ensemble in the random forest model, this ensemble may determine more accurate predicted data, particularly when the individual trees are uncorrelated with each other. In some embodiments, a random forest model implements a software algorithm that is an extension of a bagging method. As, a random forest model may use both bagging and feature randomness to create an uncorrelated forest of decision trees. Feature randomness (also referred to as “feature bagging”) may generate a random subset of input features. This random subject may thereby result in low correlation among decision trees in the random forest model. In a training operation for a random forest model, a training operation may search for decision trees that provide the best split to subset particular data, such as through a Classification and Regression Tree (CART) algorithm. Different metrics, such as information gain or mean square error (MSE), may be used to determine the quality of a data split for various decision trees.

Keeping with random forests, a random forest model may be a classifier that uses data having discrete labels or classes. Likewise, a random forest model may also be used as a random forest regressor to solve regression problems. Depending on the type of problem being addressed by the random forest model, how predicted data is determined may vary accordingly. For a regression task, the individual decision trees may be averaged in a predicted result. For a classification task, a majority vote (e.g., predicting an output based on the most frequent categorical variable) may determine a predicted class. In a random forest regressor, the model may work with data having a numeric or continuous output, which cannot be defined by distinct classes.

Turning to reinforcement learning, a reinforcement learning system may perform one or more reinforcement learning algorithms using to train a machine-learning model. For example, a reinforcement learning system may be implemented using a positioning satellite system in addition to one or more remote servers. In particular, a reinforcement learning algorithm may be a type of method that autonomously learns agent policies through multiple iterations of trials and evaluations based on observation data. The objective of a reinforcement learning algorithm may be to learn an agent policy π that maps one or more states of an environment to an action so as to maximize an expected reward J (x). A value reward may describe one or more qualities of particular state, agent action, and/or trajectory at particular time within an operation, such as an epoch for determining a location of a GPS using within a positioning satellite system. As such, a reinforcement learning system may include hardware and/or software with functionality for implementing one or more reinforcement learning algorithms. For example, a reinforcement learning algorithm may train a policy to make a sequence of decisions based on the observed states of the environment to maximize the cumulative reward determined by a reward function. For example, a reinforcement learning algorithm may employ a trial-and-error procedure to determine one or more agent policies based on various agent interactions with a complex environment, such as a positioning satellite environment with multiple base stations and GPS devices. As such, a reinforcement learning algorithm may include a reward function that teaches a particular action selection engine to follow certain rules, while still allowing the reinforcement learning model to retain information learned from previous position simulations.

In some embodiments, one or more components in a reinforcement learning system are trained using a training system. For example, an agent policy and/or a reward function may be updated through a training process that is performed by a machine-learning algorithm. In some embodiments, historical data, augmented data, and/or synthetic data may provide a supervised signal for training an action selector engine, an agent policy, and/or a reward function, such as through an imitation learning algorithm. In another embodiment, an interactive expert may provide data for adjusting agent policies and/or reward functions.

Turning to deep reinforcement learning, deep reinforcement learning may combine various machine-learning models (e.g., artificial neural networks) with a framework of reinforcement learning that helps agents learn how to reach their goals. That is, deep reinforcement learning may use both function approximation and target optimization in order to map various states and actions to specific rewards. For example, artificial neural networks as used in computer vision, natural language processing, and time series predictions may be combined with reinforcement learning algorithms.

While FIGS. 1, 2A, 2B, 2C, 3A, 3B, and 3C shows various configurations of components, other configurations may be used without departing from the scope of the disclosure. For example, various components in FIG. 1 may be combined to create a single component. As another example, the functionality performed by a single component may be performed by two or more components.

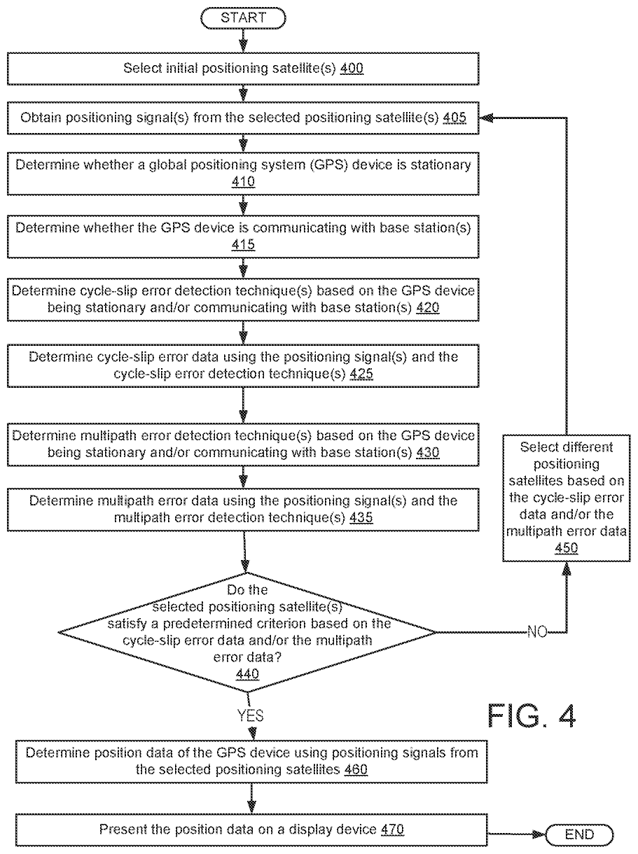

Turning to FIG. 4, FIG. 4 shows a flowchart in accordance with one or more embodiments. Specifically, FIG. 4 describes a general method for determining position data using positioning signals based on error data and adjustments of positioning satellites. One or more blocks in FIG. 4 may be performed by one or more components (e.g., GPS device A (110)) as described in FIGS. 1, 2A, 2B, 2C, 3A, 3B, and 3C. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 400, one or more initial positioning satellites are selected in accordance with one or more embodiments. For example, a GPS device may detect positioning signals from multiple positioning satellites currently visible to the GPS device. The maximum number of available positioning satellites available for determining the location of the GPS device may be used for the initial set of satellites.

In Block 405, one or more positioning signals are obtained from one or more selected positioning satellites in accordance with one or more embodiments. Using one or more receivers, a GPS device may detect one or more positioning signals from one or more positioning satellites. The GPS device may obtain carrier phase measurements as well as ephemeris data for any received positioning signals. Carrier phase data may correspond to a range between a positioning satellite and the GPS device expressed in units of cycles of a carrier frequency. Ephemeris data may include information about a positioning satellite's location (e.g., current and predicted locations), timing data, and health data.

In Block 410, a determination is made whether a GPS device is stationary in accordance with one or more embodiments. For example, a user device may collect sensor data from one or more motion sensors and/or orientation sensors to determine whether the GPS device is stationary or in a moving state. Likewise, position data from the GPS device may also be used to determine whether the location of the GPS device is currently changing or at the same location.

In Block 415, a determination is made whether a GPS device is communicating with one or more base stations in accordance with one or more embodiments. For example, a user device or a GPS device may establish a network connection over a wireless link with one or more base stations, such as for transferring position data. In the absence of a connection, a user device may determine that no connection to a base station exists.

In Block 420, one or more cycle-slip error detection techniques are determined based on a GPS device station and/or communicating with one or more base stations in accordance with one or more embodiments. For more information on cycle-slip error detection techniques for detecting cycle slip errors, see FIGS. 1, 2A-2C, and 3A-3D above and the accompanying description.

In Block 425, cycle-slip error data are determined using one or more positioning signals and one or more cycle-slip error detection techniques in accordance with one or more embodiments.

In Block 430, one or more multipath error detection techniques are determined based on a GPS device being stationary and/or communicating with one or more base stations in accordance with one or more embodiments. For more information on multipath error detection techniques for detecting multipath errors, see FIGS. 1, 2A-2C, and 3A-3D above and the accompanying description.

In Block 435, multipath error data are determined using one or more positioning signals and one or more multipath error detection techniques in accordance with one or more embodiments. In some embodiments, various multipath error detection techniques are used based on the particular GPS mode operating with a GPS device. For example, one multipath error detection technique may be based on a Code-Minus-Carrier (CMC) metric for characterizing and measuring code multipath errors by subtracting carrier phase measurements from corresponding pseudoranges. Since the pseudorange multipath error is considerably larger than that of the carrier phase, the CMC measurement may provide an indication of pseudorange multipath. Likewise, some multipath error Likewise, a GPS device may analyze positioning signals acquired from multiple receivers on multiple channels to implement measurement redundancy and determine any multipath errors accordingly.

In some embodiments, multipath error data is determined using a Carrier-to-Noise-density ratio (C/NO) metric and stochastic modeling. For example, the C/NO metric may be a single-frequency monitoring technique for detection of various multipath conditions. As, a C/NO value fluctuates as a result of the superposition of direct signals and one or more reflected signals, a GPS device may determine an amount of multipath error in a positioning signal. Additionally, multipath may be detected through the difference between pseudoranges values of positioning signals on two different carrier frequencies received at a GPS device. Likewise, other multipath error detection techniques may include differential C/NO (DC/NO)-based monitoring metric for detection and Code-Minus-Carrier (CMC) estimation for determining multipath errors. For example, a CMC technique may be performed by subtracting the carrier phase measurements from the corresponding pseudoranges to determine the effect of non-dispersive systematic errors.

In Block 440, a determination is made whether one or more selected positioning satellites satisfy one or more predetermined criteria based on a cycle-slip error data and/or multipath error data in accordance with one or more embodiments. For example, the predetermined criterion may be a threshold for identifying a particular amount of cycle-slip error and/or multipath error that is within an acceptable limit, or simply whether a cycle-slip error or a multipath error is occurring at the GPS device. Likewise, the predetermined criterion may include a specific DOP value. If the current set of positioning satellites satisfies the predetermined criterion, the process may proceed to Block 460. If the current set of positioning satellites fails to satisfy the predetermined criterion, the process may proceed to Block 450.

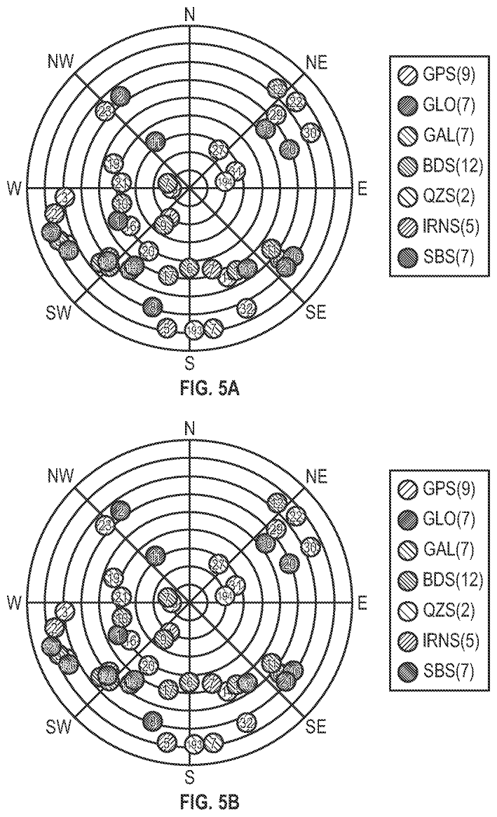

In some embodiments, one or more predetermined criteria includes whether a selection of positioning satellites includes one or more satellites based on a predetermined direction. For example, after identifying which positioning satellites are to be removed based on cycle-slip errors and/or multipath errors, a GPS device may determine whether at least one positioning satellite exists in a north direction, a south direction, an east direction, a west direction. Moreover, a predetermine criterion may correspond to a specific range from one or more directions (e.g., whether a positioning satellite is within 15 degrees of true north or 15 degrees of true south). If at least one positioning satellite does not satisfy the direction criterion, then the GPS device may determine one or more positioning satellites that experiences a cycle-slip error and/or a multipath to be included in an adjusted set of positioning satellites for determining position data. By maintaining at least one positioning satellite in each direction, the GPS device may keep the geometry of constellation unharmed for position calculations. For example, FIGS. 5A and 5B show an example of various positioning satellites being located in different directions for use in satellite selections accordingly.

In Block 450, different positioning satellites are selected based cycle-slip error data and/or multipath error data in accordance with one or more embodiments. For example, one or more positioning satellites may be added or removed from a position data calculation based on amounts of cycle-slip error, multipath error, and corresponding DOP values associated with their addition or removal. Likewise, this adjustment may be repeated iteratively with different DOP values until the best set of positioning satellites are determined without a rapid increase of the DOP value.

In Block 460, position data of a GPS device are determined using positioning signals from selected positioning satellites in accordance with one or more embodiments.

In Block 470, position data are presented on a display device in accordance with one or more embodiments. For example, position data may be shown within a graphical user interface. Likewise, position data may be integrated with one or more applications being performed in a user device, such as recommending directions to a user or managing an automated driving operation.

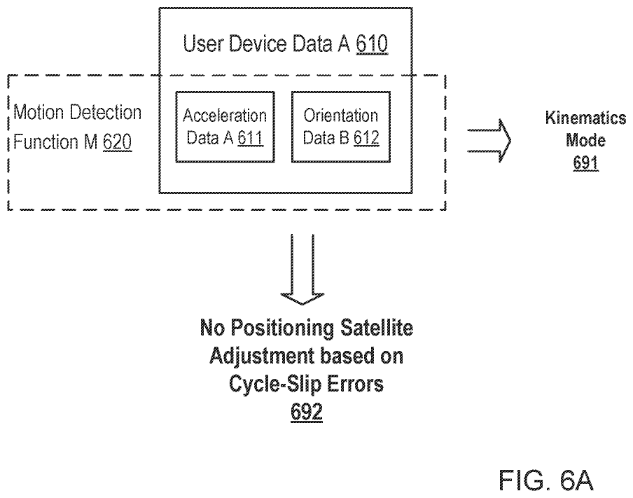

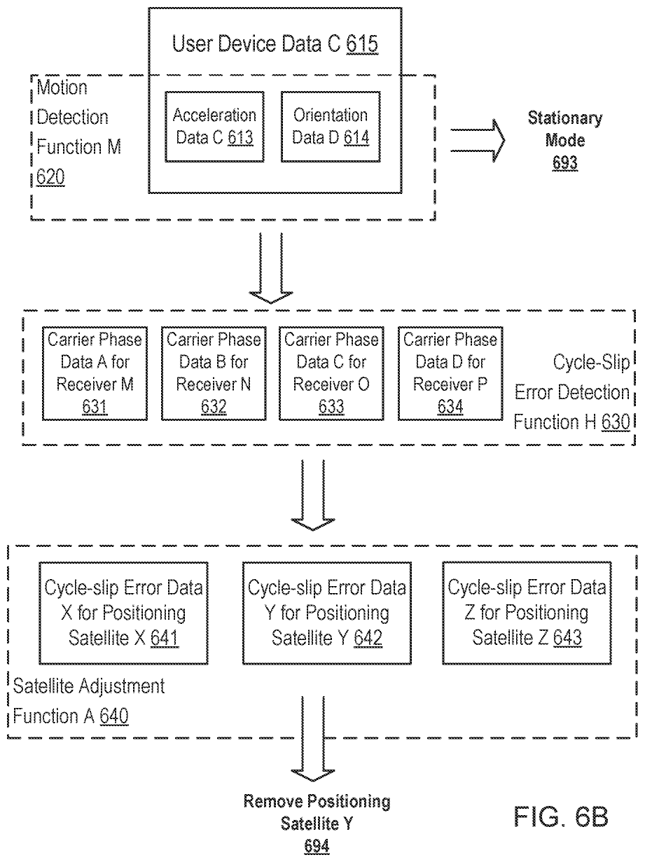

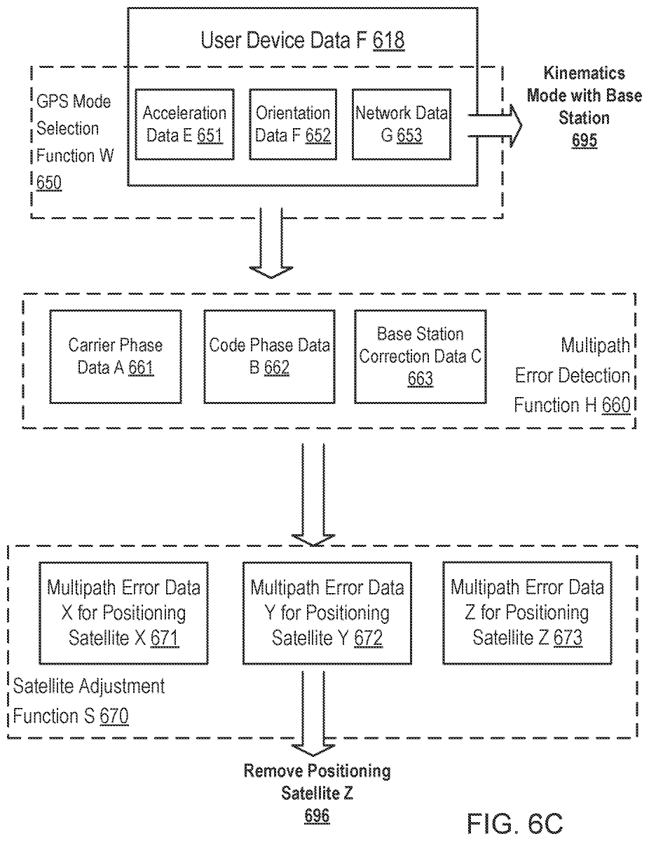

Turning to FIGS. 6A, 6B, and 6C, FIGS. 6A, 6B, and 6C provide examples of adjusting positioning satellites for a position data calculation in accordance with one or more embodiments. The following example is for explanatory purposes only and not intended to limit the scope of the disclosed technology. As shown in FIG. 6A, a user device (not shown) collects user device data A (610) from various motion sensors (e.g., accelerometers and gyroscopes), i.e., acceleration data A (611) and orientation data B (612). Using a motion detection function M (620), the user device determines that it is undergoing movement and thus a GPS device (not shown) onboard the user device will operate in a kinematics mode (691). However, due to the unpredictable nature of detecting cycle-slips in the kinematics mode (691), the user device automatically makes a determination (692) that no positioning satellite adjustments are to be made based on cycle-slip errors.

Turning to FIG. 6B, the user device again collects user device data C (615) that includes acceleration data C (613) and orientation data D (614) for inputs to the motion detection function M (620). Based on the motion detection function M (620), the user device determines that a GPS device should operate in a stationary mode (693). Based on the stationary mode (693), the user device selects a corresponding cycle-slip error detection function H (630). For inputs, the cycle-slip error detection function H (630) analyzes carrier phase data from multiple receivers in the GPS device, i.e., carrier phase data A (631) for receiver M, carrier phase data B (632) for receiver N, carrier phase data C (633) for receiver O, and carrier phase data D (634) for receiver P. The carrier phase data (631, 632, 633, 634) include positioning signal data from three positioning satellites, i.e., a positioning satellite X, a positioning satellite Y, and a positioning satellite Y. Accordingly, the user device uses the carrier phase data (631, 632, 633, 634) as inputs to the cycle-slip error detection function H (630) to determine cycle-slip error data X (641) for positioning satellite X, cycle-slip error data Y (642) for positioning satellite Y, and cycle-slip error data Z (643) for positioning satellite Z. Based on the cycle-slip error data (641, 642, 643), the user determine uses a satellite adjustment function A (640) makes an automated determination (694) that the positioning satellite Y should be removed from the position data calculation on the GPS device based on the cycle-slip errors associated with the respective positioning satellite.

In FIG. 6C, a user device collects user device data F (618) that includes acceleration data E (651), orientation data F (652), and network data G (653). In particular, the network data G (653) may describe whether any data based on a GPS network protocol is being transmitted to one or more base stations by the user device or a GPS device onboard the user device. Using a GPS mode selection function W (650), the user device makes an automated determination to operate the GPS device in a kinematics mode (695) with a base station using the user device data F (618). In this kinematics mode, the user device obtains carrier phase data A (661) and code phase data B (662) for various positioning satellites as well as base station correction data C (663) from one or more base stations. The user device then applies a multipath error detection function H (660) to the carrier phase data A (661), the code phase data B (662), and the base station correction data C (663) to determine multipath error data X (671) for a positioning satellite X, multipath error data Y (672) for a positioning satellite Y, and multipath error data Z (673) for a positioning satellite Z. Using the multipath error data (671, 672, 673), the user device applies a satellite adjustment function S (670) to make an automated determination (696) to remove positioning satellite Z from position data calculations.

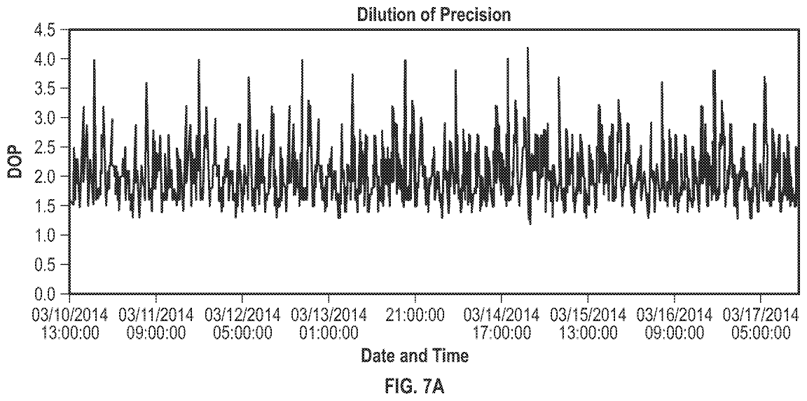

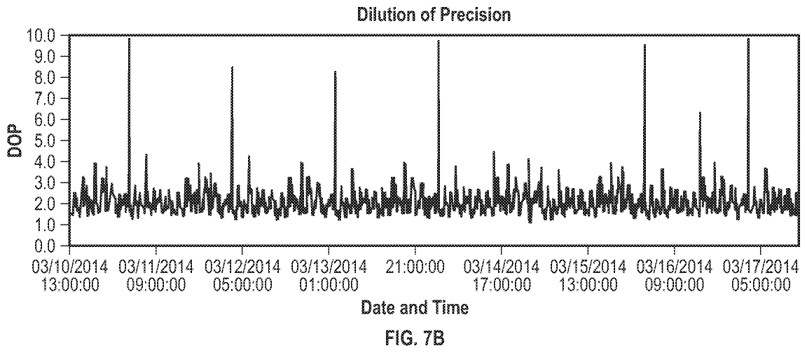

Turning to FIGS. 7A and 7B, FIGS. 7A and 7B show examples of dilution-of-precision values using a satellite adjustment technique. FIG. 7A shows the DOP values prior to any satellite removal based on cycle-slip errors and multipath errors. On the other hand, FIG. 7B shows DOP values after removal of the DOP values. As such, a 51.20% improvement in 3D positioning through eliminating positioning satellites experiencing cycle-slip and multipath errors. In particular, the 3D positioning error was determined using the following equation.

$$3 D position error = √ ( {E}_{error}^{2} + {N}_{error}^{2} + {H}_{error}^{2} ) \qquad Equation 2$$

where E corresponds to Easting position data, N corresponds to Northing position data, and H correspond to height data for the GPS device. After applying an elimination technique, the DOP value was still less than 4 over the time period except for one time a day where the DOP value jumps to 10.

Embodiments may be implemented on a computer system. FIG. 8 is a block diagram of a computer system (802) used to provide computational functionalities associated with described algorithms, methods, functions, processes, flows, and procedures as described in the instant disclosure, according to an implementation. The illustrated computer (802) is intended to encompass any computing device such as a high performance computing (HPC) device, server, desktop computer, laptop/notebook computer, wireless data port, smart phone, personal data assistant (PDA), tablet computing device, one or more computer processors within these devices, or any other suitable processing device, including both physical or virtual instances (or both) of the computing device. Additionally, the computer (802) may include a computer that includes an input device, such as a keypad, keyboard, touch screen, or other device that can accept user information, and an output device that conveys information associated with the operation of the computer (802), including digital data, visual, or audio information (or a combination of information), or a GUI.

The computer (802) can serve in a role as a client, network component, a server, a database or other persistency, or any other component (or a combination of roles) of a computer system for performing the subject matter described in the instant disclosure. The illustrated computer (802) is communicably coupled with a network (830). In some implementations, one or more components of the computer (802) may be configured to operate within environments, including cloud-computing-based, local, global, or other environment (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) can receive requests over network (830) from a client application (for example, executing on another computer (802)) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) can communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer. Software services, such as those provided by the service layer (813), provide reusable, defined business functionalities through a defined interface. For example, the interface may be software written in JAVA, C++, or other suitable language providing data in extensible markup language (XML) format or other suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (804 includes logic encoded in software or hardware (or a combination of software and hardware) and operable to communicate with the network (830). More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single processor (805) in FIG. 8, two or more computer processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that can be connected to the network (830). For example, memory (806) can be a database storing data consistent with this disclosure. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) can be external to the computer (802).

The application (807) is an algorithmic software engine providing functionality according to particular needs, desires, or particular implementations of the computer (802), particularly with respect to functionality described in this disclosure. For example, application (807) can serve as one or more components, modules, applications, etc. Further, although illustrated as a single application (807), the application (807) may be implemented as multiple applications (807) on the computer (802). In addition, although illustrated as integral to the computer (802), in alternative implementations, the application (807) can be external to the computer (802).

There may be any number of computers (802) associated with, or external to, a computer system containing computer (802), each computer (802) communicating over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers (802).

In some embodiments, the computer (802) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining, using a global positioning system (GPS) device, a first plurality of positioning signals for a first plurality of positioning satellites, wherein the GPS device comprises a first receiver, a computer processor, an antenna, and a communication interface;
determining, by the GPS device, whether the GPS device is stationary;
determining, by the GPS device, whether the GPS device is receiving position correction data from a first base station using the communication interface;
determining, by the GPS device, a first cycle-slip error detection technique in response to determining that the GPS device is not stationary and the GPS device is receiving the position correction data from the first base station;
determining, by the GPS device, cycle-slip error data using the first cycle-slip error detection technique and the first plurality of positioning signals;
determining, by the GPS device, a first multipath error detection technique in response to determining that the GPS device is not stationary and the GPS device is receiving the position correction data from the first base station; and
determining, by the GPS device, multipath error data using the first multipath error detection technique and the first plurality of positioning signals;
determining, by the GPS device, whether the first plurality of positioning satellites satisfy a first predetermined criterion based on the cycle-slip error data and the multipath error data;
determining, by the GPS device, a second plurality of positioning satellites in response to determining that the first plurality of positioning satellites fail to satisfy the first predetermined criterion, wherein the first plurality of positioning satellites are different from the second plurality of positioning satellites;
obtaining, by the GPS device, a second plurality of positioning signals using the second plurality of positioning satellites; and
determining, by the GPS device, first position data using the second plurality of positioning signals.

2. The method of claim 1, further comprising:
obtaining a third plurality of positioning signals for a third plurality of positioning satellites;
determining, based on the third plurality of positioning signals, a respective direction for a respective positioning satellite among the third plurality of positioning signals;
determining whether the third plurality of positioning satellites satisfies the first predetermined criterion and a second predetermined criterion,
wherein the second predetermined criterion corresponds to at least one satellite from the third plurality of positioning satellites corresponding to a predetermined range from a north direction, a south direction, an east direction, and a west direction;
determining, in response to the third plurality of positioning satellites failing to satisfy the first predetermined criterion and the second predetermined criterion, a plurality of adjusted positioning satellites that is different from the third plurality of positioning satellites; and
determining second position data based on a fourth plurality of positioning signals for the plurality of adjusted positioning satellites.

3. The method of claim 1, further comprising:
determining first carrier phase data of a first positioning signal using the first receiver; and
determining second carrier phase data of a second positioning signal using a second receiver at the GPS device,
wherein the cycle-slip error data is determined based on a difference between the first carrier phase data and the second carrier phase data.

4. The method of claim 1, further comprising:
obtaining a first positioning signal from a first positioning satellite, a second positioning signal from a second positioning satellite, and a third positioning signal from a third positioning satellite; and
determining, using a machine-learning model and based on the first positioning signal, the second positioning signal, and the third positioning signal, a first cycle-slip error value for the first positioning satellite, a second cycle-slip error value for the second positioning satellite, and a third cycle-slip error value for the third positioning satellite,
wherein the cycle-slip error data comprises the first cycle-slip error value, the second cycle-slip error value, and the third cycle-slip error value.

5. The method of claim 1, further comprising:
determining carrier phase data using the first receiver in the GPS device;
obtaining a first positioning signal from a first positioning satellite, a second positioning signal from a second positioning satellite, and a third positioning signal from a third positioning satellite;
obtaining second position correction data from a second base station using a GPS network protocol; and
determining pseudorange data of the first positioning satellite, the second positioning satellite, and the third positioning satellite using the first positioning signal, the second positioning signal, and the third positioning signal,
wherein the multipath error data is determined based on the carrier phase data, the pseudorange data, and second position correction data from the second base station.

6. The method of claim 1, further comprising:
determining first multipath error value for a first positioning satellite;
determining second multipath error value for a second positioning satellite;
determining third multipath error value for a third positioning satellite;
determining dilution-of-precision (DOP) data for the first positioning satellite, the second positioning satellite, and the third positioning satellite using a second plurality of positioning signals; and
wherein the first plurality of positioning satellites is adjusted to produce the second plurality of positioning satellites based on the DOP data.

7. The method of claim 1, further comprising:
obtaining a first positioning signal from a first positioning satellite, a second positioning signal from a second positioning satellite, and a third positioning signal from a third positioning satellite; and
determining, using a machine-learning model, a first multipath error value for the first positioning satellite, a second multipath error value for the second positioning satellite, and a third multipath error value for the third positioning satellite,
wherein the multipath error data comprises the first multipath error value, the second multipath error value, and the third multipath error value.

8. The method of claim 1, further comprising:
determining the GPS device is in a stationary mode based on whether the GPS device is moving using an accelerometer in a user device.

9. The method of claim 1,
wherein determining the GPS device is receiving position correction data from the first base station comprising communicating with the first base station using a Radio Technical Commission for Maritime Services (RTCM) protocol.

10. The method of claim 1,
wherein the first predetermined criterion comprises a predetermined dilution-of-precision (DOP) threshold.

11. A system, comprising:
a plurality of positioning satellites;
a first base station; and
a global position system (GPS) device, wherein the GPS device comprises a first receiver, a memory, a computer processor, an antenna, and a communication interface;
wherein the memory comprises instructions executable by the computer processor and configured to perform a method comprising:
obtaining a first plurality of positioning signals for a first subset of the plurality of positioning satellites;
determining whether the GPS device is stationary;
determining whether the GPS device is receiving position correction data from the first base station using the communication interface;
determining a first cycle-slip error detection technique in response to determining that the GPS device is not stationary and the GPS device is receiving the position correction data from the first base station;
determining cycle-slip error data using the first cycle-slip error detection technique and the first plurality of positioning signals;
determining a first multipath error detection technique in response to determining that the GPS device is not stationary and the GPS device is receiving the position correction data from the first base station; and
determining multipath error data using the first multipath error detection technique and the first plurality of positioning signals;
determining whether the first subset of plurality of positioning satellites satisfy a first predetermined criterion based on the cycle-slip error data and the multipath error data;
determining a second subset of plurality of positioning satellites in response to determining that the first subset of plurality of positioning satellites fail to satisfy the first predetermined criterion, wherein the second subset of plurality of positioning satellites are different from the first subset of the plurality of positioning satellites;
obtaining a second plurality of positioning signals using the second subset of plurality of positioning satellites; and
determining first position data using the second plurality of positioning signals.

12. The system of claim 11, wherein the method further comprises:
obtaining a third plurality of positioning signals for a third plurality of positioning satellites;
determining, based on the third plurality of positioning signals, a respective direction for a respective positioning satellite among the third plurality of positioning signals;
determining whether the third plurality of positioning satellites satisfies the first predetermined criterion and a second predetermined criterion,
wherein the second predetermined criterion corresponds to at least one satellite from the third plurality of positioning satellites corresponding to a predetermined range from a north direction, a south direction, an east direction, and a west direction;
determining, in response to the third plurality of positioning satellites failing to satisfy the first predetermined criterion and the second predetermined criterion, a plurality of adjusted positioning satellites that is different from the third plurality of positioning satellites; and
determining second position data based on a fourth plurality of positioning signals for the plurality of adjusted positioning satellites.

13. The system of claim 11, wherein the method further comprises:
determining first carrier phase data of a first positioning signal using the first receiver; and
determining second carrier phase data of a second positioning signal using a second receiver at the GPS device,
wherein the cycle-slip error data is determined based on a difference between the first carrier phase data and the second carrier phase data.

14. The system of claim 11, further comprising:
a server coupled to the first base station, wherein the server comprises a machine-learning model,
wherein the server is configured to obtain a first positioning signal from a first positioning satellite, a second positioning signal from a second positioning satellite, and a third positioning signal from a third positioning satellite; and
wherein the server is further configured to determine, using the machine-learning model and the first position data for the GPS device, and based on the first positioning signal, the second positioning signal, and the third positioning signal, a first cycle-slip error value for the first positioning satellite, a second cycle-slip error value for the second positioning satellite, and a third cycle-slip error value for the third positioning satellite,
wherein the server is further configured to transmit the cycle-slip error data to the GPS device using the first base station, and
wherein the cycle-slip error data comprises the first cycle-slip error value, the second cycle-slip error value, and the third cycle-slip error value.

15. The system of claim 11, wherein the method further comprises:
determining carrier phase data using the first receiver in the GPS device;
obtaining a first positioning signal from a first positioning satellite, a second positioning signal from a second positioning satellite, and a third positioning signal from a third positioning satellite;
obtaining second position correction data from a second base station using a GPS network protocol; and
determining pseudorange data of the first positioning satellite, the second positioning satellite, and the third positioning satellite using the first positioning signal, the second positioning signal, and the third positioning signal,
wherein the multipath error data is determined based on the carrier phase data, the pseudorange data, and second position correction data from the second base station.

16. The system of claim 11, wherein the method further comprises:
determining first multipath error value for a first positioning satellite;
determining second multipath error value for a second positioning satellite;
determining third multipath error value for a third positioning satellite;
determining dilution-of-precision (DOP) data for the first positioning satellite, the second positioning satellite, and the third positioning satellite using a second plurality of positioning signals; and
wherein the first subset of the plurality of positioning satellites is adjusted to produce the second subset of the plurality of positioning satellites based on the DOP data.

17. The system of claim 11, wherein the method further comprises:
obtaining a first positioning signal from a first positioning satellite, a second positioning signal from a second positioning satellite, and a third positioning signal from a third positioning satellite; and
determining, using a machine-learning model, a first multipath error value for the first positioning satellite, a second multipath error value for the second positioning satellite, and a third multipath error value for the third positioning satellite,
wherein the multipath error data comprises the first multipath error value, the second multipath error value, and the third multipath error value, and
wherein the machine-learning model is stored on the first base station.

18. The system of claim 11, further comprising:
a user device comprising the GPS device, an accelerometer, and a display device,
wherein the GPS device is determined to be in a stationary mode using the accelerometer, and
wherein the first position data is presented on the display device.

19. The system of claim 11,
wherein determining the GPS device is receiving the position correction data from the first base station comprising communicating with the first base station using a Radio Technical Commission for Maritime Services (RTCM) protocol.

20. The system of claim 11,
wherein the first predetermined criterion comprises a predetermined dilution-of-precision (DOP) threshold.
